(19) United States
(12) Patent Application Publication
(10) Pub. No.: US 2018/0067774 A1
(43) Pub. Date: Mar. 8, 2018

(54) SYSTEM FOR INFORMATION PROCESSING

(71) Applicant: FUJITSU LIMITED, Kawasaki-shi (JP)

(72) Inventor: Wataru KIKUCHI, Kawasaki (JP)

(73) Assignee: FUJITSU LIMITED, Kawasaki-shi (JP)

(21) Appl. No.: 15/687,586

(22) Filed: Aug. 28, 2017

(30) Foreign Application Priority Data
Sep. 8, 2016 (JP) 2016-175895

(51) Int. Cl. G06F 9/50

(52) U.S. Cl. CPC G06F 9/505; G06F 9/5044

(57) ABSTRACT

An information processing system comprises a plurality of information processing apparatuses. The information processing apparatus is configured to be connected in a communicable manner. Each of the information processing apparatuses includes a control unit. The control unit is set attributes corresponding to executable processes. The control unit includes a memory and a processor coupled to the memory. The processor is conrigured to perform retaining an associative relation between processes executed by any of the controling and the attributes enabling execution of the processes, accepting a process execution request, selecting the control unit to execute the process with the execution request being accepted in accordance with the associative relation, and requesting the selected control unit to execute the requested process.

### CROSS-REFERENCE TO RELATED APPLICATION

This application is based upon and claims the benefit of priority of the prior Japanese Patent Application No. 2016-175895, filed on Sep. 8, 2016, the entire contents of which are incorporated herein by reference.

### Field

The embodiments discussed herein are related to an information processing system.

### Background

An information processing system is utilized, the information processing system being configured to include a plurality of information processing apparatuses connected in a communicable manner and each being equipped with hardware resources and a control unit to control the hardware resources. The control unit is also referred to as firmware.

### Documents of Related Arts

[Patent document]
[Patent document 1] Japanese Laid-open Patent Publication No. 2003-208414
[Patent document 2] Japanese Laid-open Patent Publication No. 10-161987

### SUMMARY

According to an aspect of the embodiments, an information processing system comprises a plurality of information processing apparatuses. The information processing apparatus is configured to be connected in a communicable manner. Each of the information processing apparatuses includes a control unit. The control unit is set attributes corresponding to executable processes. The control unit includes a memory and a processor coupled to the memory. The processor is conrigured to perform retaining an associative relation between processes executed by any of the controling and the attributes enabling execution of the processes, accepting a process execution request, selecting the control unit to execute the process with the execution request being accepted in accordance with the associative relation, and requesting the selected control unit to execute the requested process.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating one example of an information processing system according to an embodiment;

FIG. 2 is a diagram illustrating one example a configuration of a server;

FIG. 3 is a diagram illustrating one example of a configuration of a service processor;

FIG. 4 is a diagram illustrating one example of attributes of firmware;

FIG. 5 is a diagram illustrating one example of a table in which to classify processes to be executed by the firmware;

FIG. 6 is a diagram illustrating one example of processing blocks of the firmware;

FIG. 7 is a diagram illustrating one example of process information;

FIG. 8 is a diagram illustrating one example of server information;

FIG. 9 is a flowchart illustrating one example of a processing flow when accepting a process request from a user;

FIG. 10 is a flowchart illustrating one example of an allocation pattern generation process matching with the attributes of the firmware;

FIG. 11 is a flowchart illustrating one example of a process of allocating a process of receiving an execution request to each firmware;

FIG. 12 is a flowchart illustrating one example of a process of returning to an invoking source upon completing a requested Process;

FIG. 13 is a flowchart illustrating one example of a process of selecting a server exhibiting a low load;

FIGS. 14A and 14B are diagrams illustrating one example of a process of turning ON a power source of a partition in the information processing system according to the embodiment; and

FIGS. 15A and 15B are diagrams illustrating one example of a processing flow of turning ON the power source of the partition in the information processing system according to a comparative example.

### DESCRIPTION OF EMBODIMENTS

Attributes corresponding to executable processes are set in a control unit equipped in an information processing apparatus. The control unit executes, based on the set attributes, e.g., a process of accepting a process request from a user and other equivalent persons, a process of alive-monitoring other information processing apparatuses, and a process of controlling the self apparatus. In an information processing system, the control unit is requested for processes of turning ON a power source of each information processing apparatus, setting a communication path, and executing an arithmetic process. The requested processes are executed by the control unit accepting a process request. Consequently, a processing load is biased to the control unit in which to set an attribute for accepting the process execution request given from the user and other equivalent persons.

An information processing system according to one embodiment will hereinafter be described with reference to the drawings. A configuration of the following embodiment is an exemplification, and a technology of the disclosure is not limited to the configuration of the embodiment.

### First Embodiment

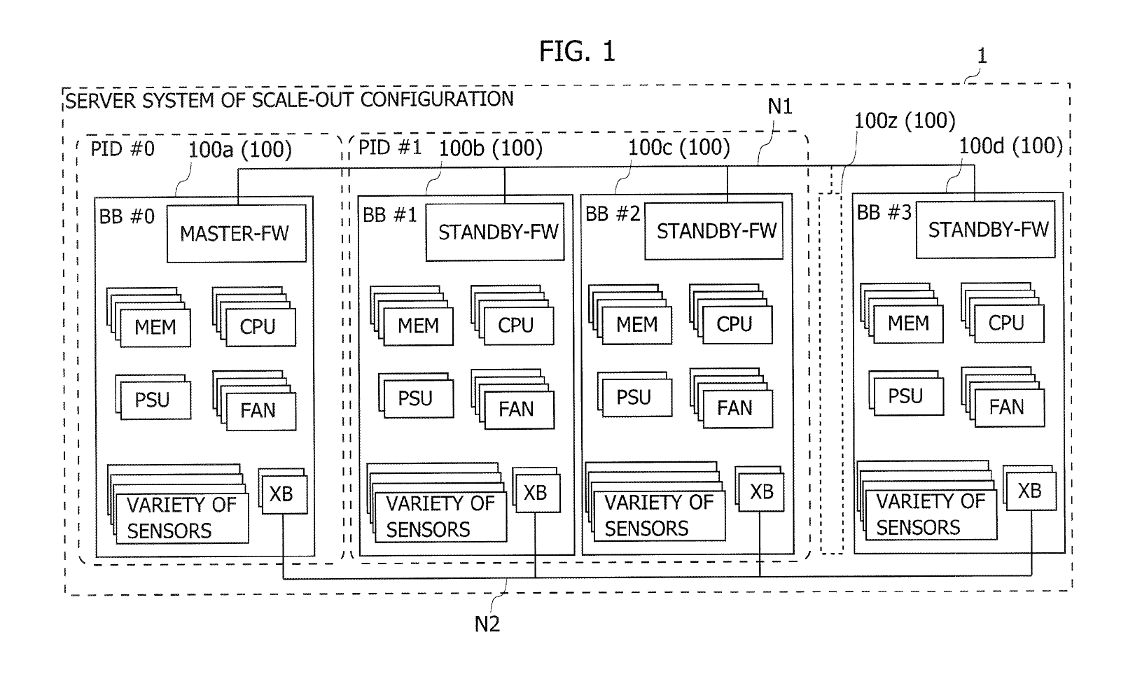

FIG. 1 is a diagram illustrating one example of an information processing system 1 according to the embodiment. The information processing system 1 includes four servers 100a, 100b, 100c and 100d. The information processing system 1 can include the five servers 100 at the maximum, but the fifth server 100, i.e., a server 100z is not connected to the information processing system 1. The servers 100a, 100b, 100c, 100d and 100z are generically termed the servers 100. The information processing system 1 is a system based on a so-called scale-out configuration. The system based on the scale-out configuration can create a partition by combining one or a plurality of servers 100. The created partition can operate as an independent information processing apparatus. A partition configuration in the information processing system 1 is enabled to change also during an operation of the information processing system 1. The change of the partition configuration includes, e.g., creating a new partition, adding the server 100 to the already created partition, and deleting the server 100 from the already created partition. For example, when a processing load on the partition increases, the information processing system 1 adds the server 100 to this partition and is thereby enabled to improve a throughput of the partition. A partition ID for identifying the partition is allocated to the individual partition. The partition ID is abbreviated to PID. In FIG. 1, e.g., a partition PID#0 includes the server 100a, and a partition PID#1 includes the server 100b and the server 100c. the embodiment will hereinafter be described with reference to the drawings.

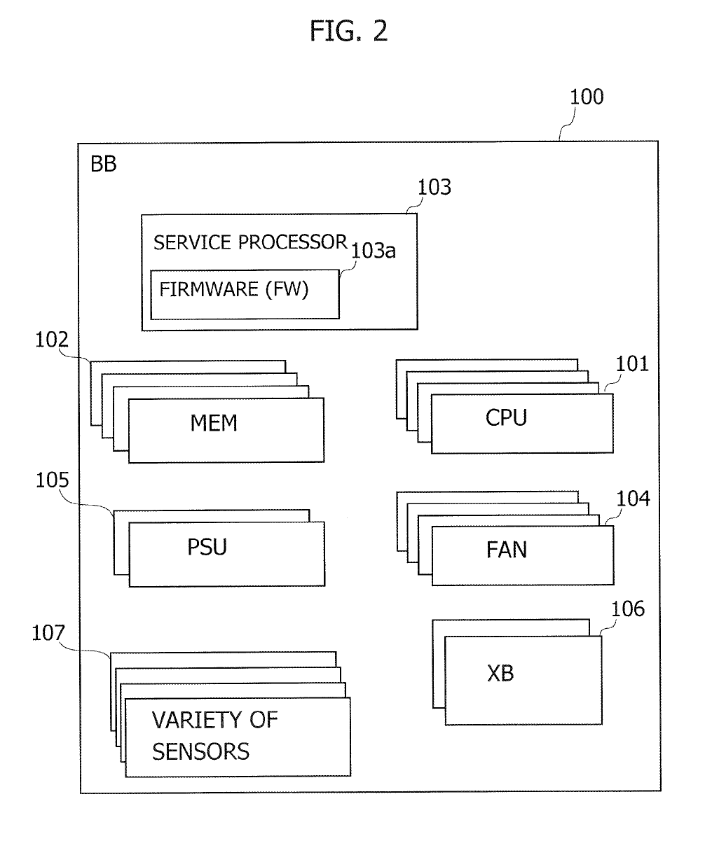

The server 100 is an information processing apparatus. The server 100 is also referred to as a building block and is notated by “BB” throughout the drawings. FIG. 2 is a diagram illustrating one example of a configuration of the server 100. The server 100 includes a Central Processing Unit (CPU) 10, a memory 102 (written as MEM in the drawings), a service processor 103, a fan 104 (written as FAN in the drawings), a Power Supply Unit (PSU) 105, a Cross Bar (XB) 106, and a variety of sensors 107. The CPU 101, the memory 102, the service processor 103, the fan 104, the PSU 105, the XB 106 and the variety of sensors 107 are interconnected via an unillustrated bus.

In the server 100, the CPU 101 controls peripheral devices through running a program stored in the memory 102. The server 100 is thereby enabled to execute processes conforming to predetermined purposes. The memory 102 is a recording medium readable by the server 100.

The memory 102 is exemplified by a storage unit to be accessed from the CPU 101. The memory 102 includes a Random Access Memory (RAM), a Read Only Memory (ROM), and an auxiliary storage unit.

The fan 104 cools down the server 100 by blowing the air into the server 100. The XB 106 is a communication interface with other servers 100. The XB 106 performs communications with other servers 100 via a network N2. The variety of sensors 107 are, e.g., temperature sensors or voltage sensors. Upon detecting abnormality of a temperature within the server 100 or a voltage supplied to the server 100, the sensor 107 notifies OS or firmware 103a running on the server 100 of the abnormality.

The server 100 may further include an input unit to accept an operation instruction and other equivalent instructions from a user and other equivalent persons. This type of input unit can be exemplified by an input device like a keyboard, a pointing device, a touch panel, an acceleration sensor, or a voice input device.

The server 100 may be configured to include, e.g., an output unit that outputs data to be processed by the CPU 101 and data to be stored in the memory 102. This type of output unit can be exemplified by an output device like a Cathode Ray Tube (CRT) display, a Liquid Crystal Display (LCD), a Plasma Display Panel (PDP), an Electroluminescence (EL) panel, an organic EL panel, or a printer.

The PSU 105 supplies electric power to the server 100. The PSU 105 includes a resident power source and a non-resident power source. The resident power source supplies the power to part of hardware mounted on the server 100 even in a status of a power switch being turned OFF. The resident power source supplies the electric power to, e.g., the service processor 103. The non-resident power source supplies the electric power to the respective hardware components mounted on the server 100 upon turning ON the power switch of the server 100. The server 100 is supplied with the electric power from the non-resident power source, and is thereby enabled to execute a variety of information processes.

A network N1 is a computer network via which the service processors 103 mounted on the servers 100 are interconnected. The service processor 103 of the server 100 can perform communications with the service processors 103 mounted on other servers 100 via the network N1. The network N2 is a computer network via which the XBs 106 mounted on the servers 100 are interconnected. The servers 100 are communication-enabled with each other via the network N2. The networks N1, N2 are not limited to any specified protocols for use thereof. Each of the networks N1, N2 is, e.g., a Local Area Network (LAN). Each of the networks N1, N2 may be a wired network and may also be a wireless network.

The service processor 103 is an information processing apparatus mounted on the server 100. The service processor 103 includes the firmware 103a. The firmware 103a controls hardware resources of, e.g., the server 100. The firmware 103a creates the partition by combining the servers 100 in response to a request given from the user. The service processor 103 operates by the electric power supplied from the resident power source of the PSU 105. The service processor 103 is therefore operable even in the status of the power switch of the server 100 being turned OFF. The service processor 103 is one example of a “control unit”.

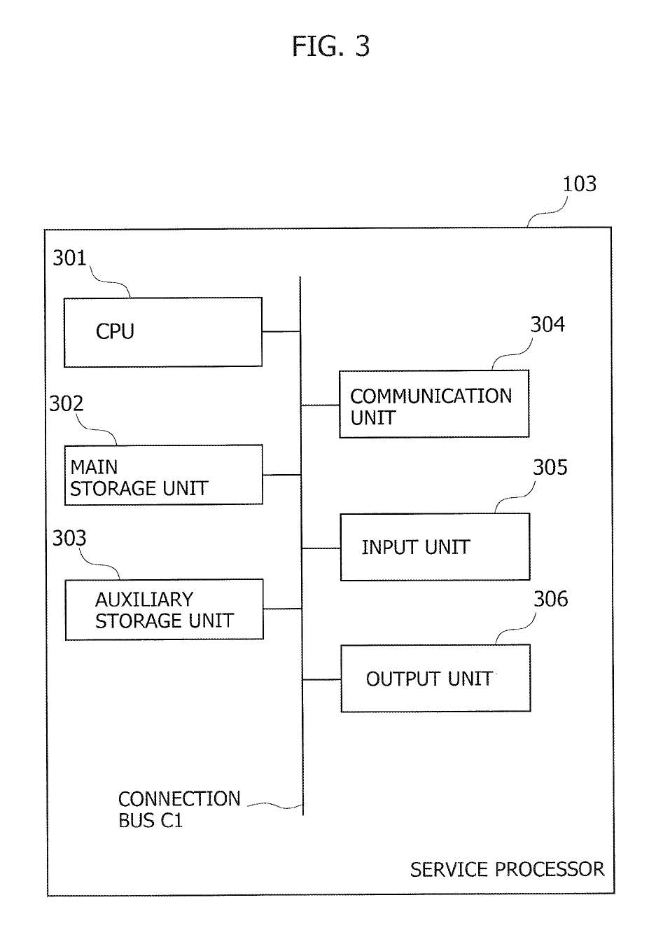

FIG. 3 is a diagram illustrating one example of a configuration of the service processor 103. The service processor 103 includes a CPU 301, a main storage unit 302, an auxiliary storage unit 303, a communication unit 304, an input unit 305, and an output unit 306. The CPU 301, the main storage unit 302, the auxiliary storage unit 303, the communication unit 304, the input unit 305 and the output unit 306 are interconnected via a connection bus C1.

In the service processor 103, the CPU 301 deploys a program stored in the auxiliary storage unit 303 onto a work area of the main storage unit 302, and controls peripheral devices through running the program. The service processor 103 is thereby enabled to execute processes conforming to predetermined purposes. The main storage unit 302 and the auxiliary storage unit 303 are non-transitory recording mediums readable by the service processor 103.

The main storage unit 302 is exemplified as a storage unit that is accessed directly from the CPU 301. The main storage unit 302 includes a Random Access Memory (RAM) and a Read Only Memory (ROM).

The auxiliary storage unit 303 may store various categories of programs and various items of data in the recording medium in a readable/writable manner. The auxiliary storage unit 303 is also called an external storage device. The auxiliary storage unit 303 stores Operating System (OS), the firmware 103a, the various categories of programs and various types of tables. The OS includes a communication interface program for transferring and receiving the data to and from the external devices connected via a communication unit 204. The external devices include the service processors 103 mounted on other servers 100 connected via, e.g., the network N1, and external storage devices.

The auxiliary storage unit 303 is exemplified by an Erasable Programmable ROM (EPROM), a Solid State Drive (SSD), and a Hard Disk Drive (HDD). The auxiliary storage unit 303 is further exemplified by a Compact Disc (CD) drive, a Digital Versatile Disc (DVD) drive, and a Blu-ray Disc (BD) drive. The auxiliary storage unit 303 may be provided by a Network Attached Storage (NAS) or a Storage Area Network (SAN).

The recording medium readable by the service processor 103 connotes a recording medium capable of accumulating information instanced by data, programs and other equivalent information electrically, magnetically, optically, mechanically or by chemical action, which can be read from the service processor 103. Among these recording mediums, the mediums removable from the service processor 103 are exemplified by a flexible disc, a magneto-optic disc, a CD-ROM, a CD-R/W, a DVD, a Blu-ray disc, a DAT, an 8 mm tape, and a memory card like a flash memory. The hard disc, the SSD, or the ROM and other equivalent recording mediums are given as the recording mediums fixed within the service processor 103.

The communication unit 304 is an interface with, e.g., the network N1. The communication unit 304 performs the communications with the service processors 103 mounted on other servers 100 via the network N1.

The input unit 305 is a user interface that accepts the operation instruction and other equivalent instructions from the user and other equivalent persons. The input unit 305 can be exemplified by an input device like a keyboard, a pointing device, a touch panel, an acceleration sensor or a voice input device.

The output unit 306 outputs data to be processed by the CPU 301 and data to be stored in the main storage unit 302. The output unit 306 can be exemplified by the output device like the Cathode Ray Tube (CRT) display, the Liquid Crystal Display (LCD), the Plasma Display Panel (PDP), the Electroluminescence (EL) panel, the organic EL panel, or the printer.

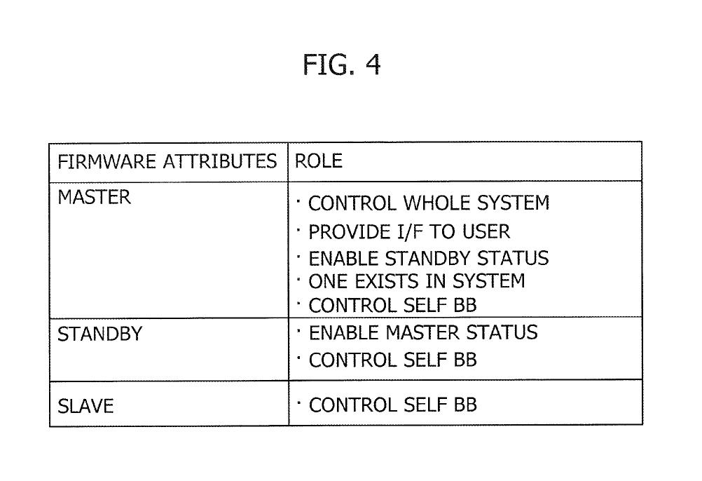

FIG. 4 is a diagram illustrating attributes of the firmware 103a. The attributes corresponding to executable processes are set in the firmware 103a. The attributes are classified into, e.g., Master attributes, Standby attributes and a Slave attribute. The firmware 103a having the Master attributes manages the information processing system 1 as a whole. In other words, the firmware 103a having Master attributes creates or deletes the partition, and turns ON the power source of the server 100. The firmware 103a having the Master attributes provides the user interface used for operating the firmware 103a. The firmware 103a having the Standby attributes can operate as the firmware 103a having the Master attributes when the firmware 103a having the Master attributes does not normally operate due to some sort of event. The firmware 103a having the Master attributes, the firmware 103a having the Standby attributes and the firmware 103a having the Slave attribute can manage the servers 100 mounted with the service processors 103 into which the pieces of firmware 103a themselves are introduced. The firmware 103a having the Master attributes exist by one within the information processing system 1. Plural pieces of firmware 103a having the Standby attributes or the Slave attributes may exist within the information processing system 1.

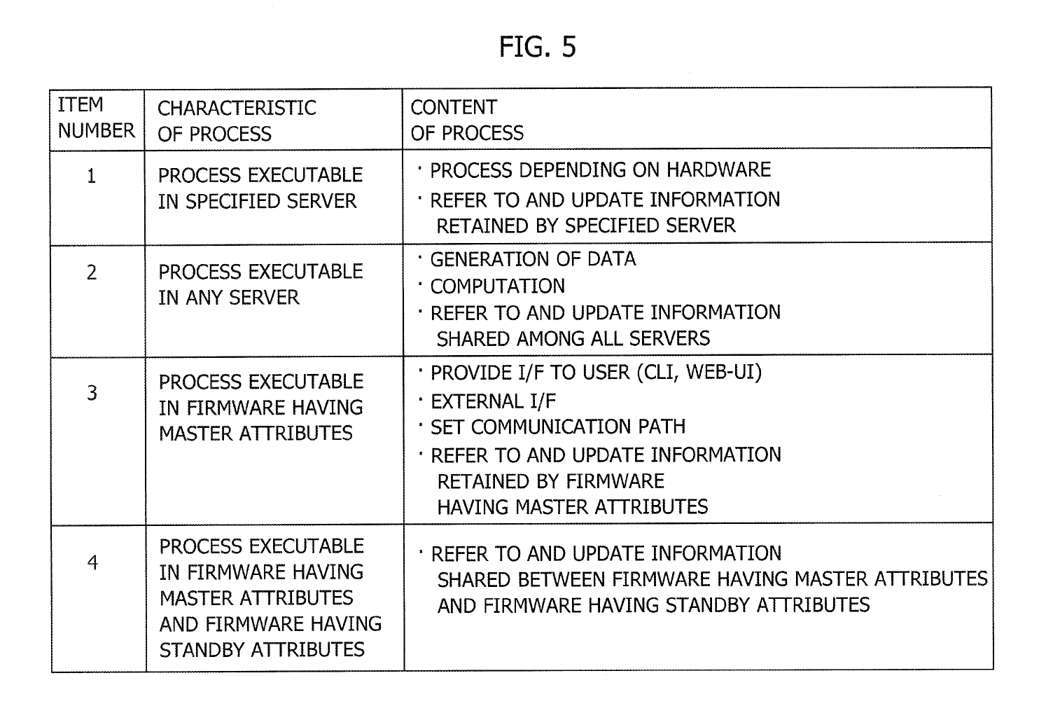

FIG. 5 illustrates one example of a table structured to classify processes to be executed by the firmware 103a. The classification of the processes to be executed by the firmware 103a will be described with reference to the table in FIG. 5. As illustrated in FIG. 5, the processes to be executed by the firmware 103a can be classified into “a process executable by a specified server”, “a process executable by any server”, “a process executable by the firmware having the Master attributes”, and “a process executable by the firmware having the Master attributes and the firmware having the Standby attributes”.

“The process executable by the specified server” can be exemplified by a process for the hardware resources equipped in the individual server 100, and referring to or updating information retained by the specified server 100. “The process executable by any server” can be exemplified by referring to and updating information shared among all the servers 100. “The process executable by any server” is, in other words, a process executable by the firmware 103a having any of the Master attributes, the Standby attributes and the Slave attribute. “The process executable by any server” can be further exemplified by a variety of computation processes, and generating data based on the information shared among all the servers 100. “The process executable by the firmware having the Master attributes” can be exemplified by providing the user interface, providing an interface with the external devices, and setting a communication path. “The process executable by the firmware having the Master attributes” can be further exemplified by referring to and updating information retained by the firmware 103a having the Master attributes. “The process executable by the firmware having the Master attributes and the firmware having the Standby attributes” can be exemplified by referring to and updating the information shared between the firmware 103a having the Master attributes and the firmware 103a having the Standby attributes.

<Processing Blocks>

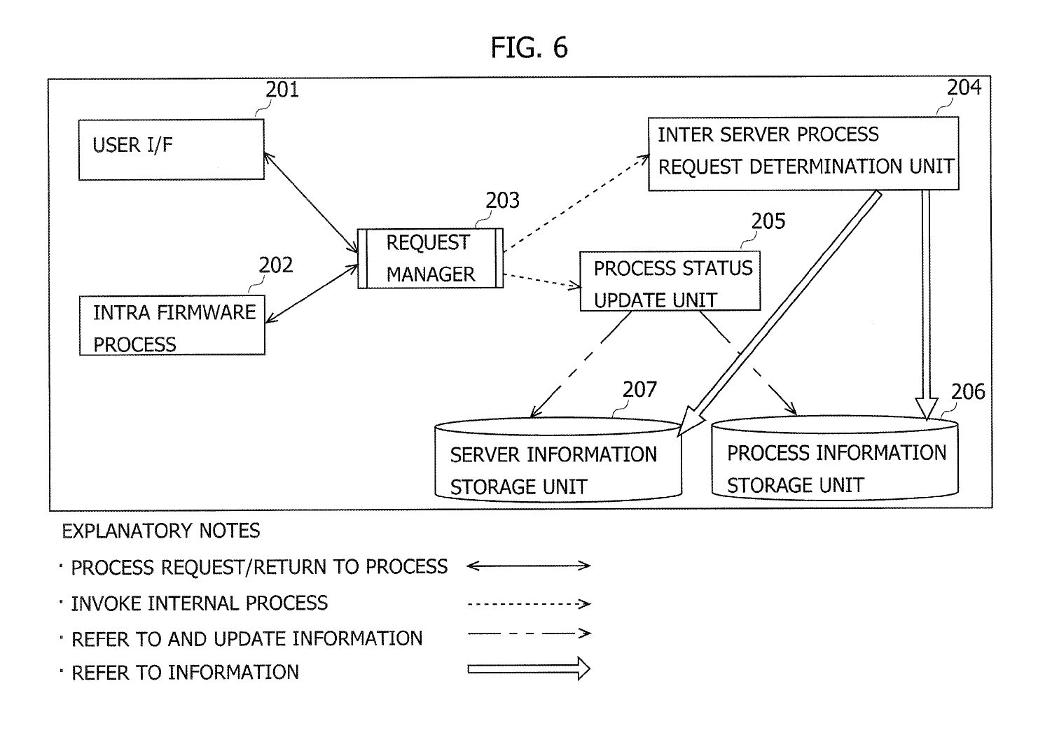

FIG. 6 is a diagram illustrating one example of processing blocks of the firmware 103a. In FIG. 6, the processing blocks of the firmware 103a are exemplified by a user interface (user I/F) 201, an intra firmware Process 202, a request manager 203, an inter server process request determination unit 204, and a process status update unit 205. FIG. 6 further illustrates a process information storage unit 206 and a server information storage unit 207 each exemplified as a storage unit. The process information storage unit 206 and the server information storage unit 207 are built up on, e.g., the main storage unit 302.

The service processor 103 includes, as illustrated in FIG. 3, the CPU 301 and the main storage unit 302, and executes the processes as the processing blocks depicted in FIG. 6, based on the computer program deployed in the executable manner on the main storage unit 302. The CPU 301 is also called a Micro Processing Unit (MPU) (Microprocessor) or a processor. It does not mean that the CPU 301 is limited to a single processor, but the CPU 301 may take a multiprocessor configuration. The single CPU 301 connected by a single socket may also take a multicore configuration. At least part of the processes of the processing blocks may be executed by a processor other than the CPU 301, i.e., a dedicated processor instanced by a Digital Signal Processor (DSP), a Graphics Processing Unit (GPU), a numerical data processor, a vector processor and an image processing processor. At least part of the processes of the processing blocks in FIG. 6 may also be attained by an integrated circuit (IC) and other digital circuits. At least part of the processing blocks may include analog circuits. The Integrated circuit includes an LSI, an Application Specific Integrated Circuit (ASIC), and a Programmable Logic Device (PLD). The PLD includes, e.g., a Field-Programmable Gate Array (FPGA). The processing block may be a combination of the processor and the integrated circuit. The combination is called, e.g., a microcontroller (MPU (Micro Control Unit)), an SoC (System-on-a-chip), a system LSI and a chipset.

The user I/F 201 is a program to notify the request manager 203 of a request given from the user. The user I/F 201 notifies the request notifies the request manager 203 of the user's process request inputted via, e.g., the input unit 305.

The intra firmware Process 202 is a generic term of a Process group that executes the variety of processes within the firmware 103a. The intra firmware Process 202 includes a user Process and a system Process. The user Process is a Process started up by inputting, e.g., a command to the user I/F 201. The system Process is a Process started up by, e.g., the OS. The Process included by the intra firmware Process 202 executes the process in response to the process request given from, e.g., the request manager 203. The Process included by the intra firmware Process 202 can request another Process for processing. The Process included by the intra firmware Process 202 may request another Process for processing via the request manager 203 when requesting another Process for processing.

The request manager 203 accepts a process execution request from the user I/F 201 or the intra firmware Process 202. The request manager 203 accepting the process execution request determines which server 100 causes its firmware 103a to execute the accepted process. The request manager 203 requests the firmware 103a of the determined server 100 to execute the process. The process executed by the request manager 203 is one example of an “accepting”, a “selecting” and a “requesting”.

The inter server process request determination unit 204 acquires a load status of each server 100 from the server information storage unit 207. The inter server process request determination unit 204 further acquires information about a processing load of the Process included by the intra firmware Process 202 from the process information storage unit 206. The inter server process request determination unit 204 selects the server 100 capable of executing the requested process, based on the acquired information. The process executed by the inter server process request determination unit 204 is one example of the “selecting”.

The process status update unit 205 updates the server information storage unit 207 and the process information storage unit 206 in response to a request given from the request manager 203.

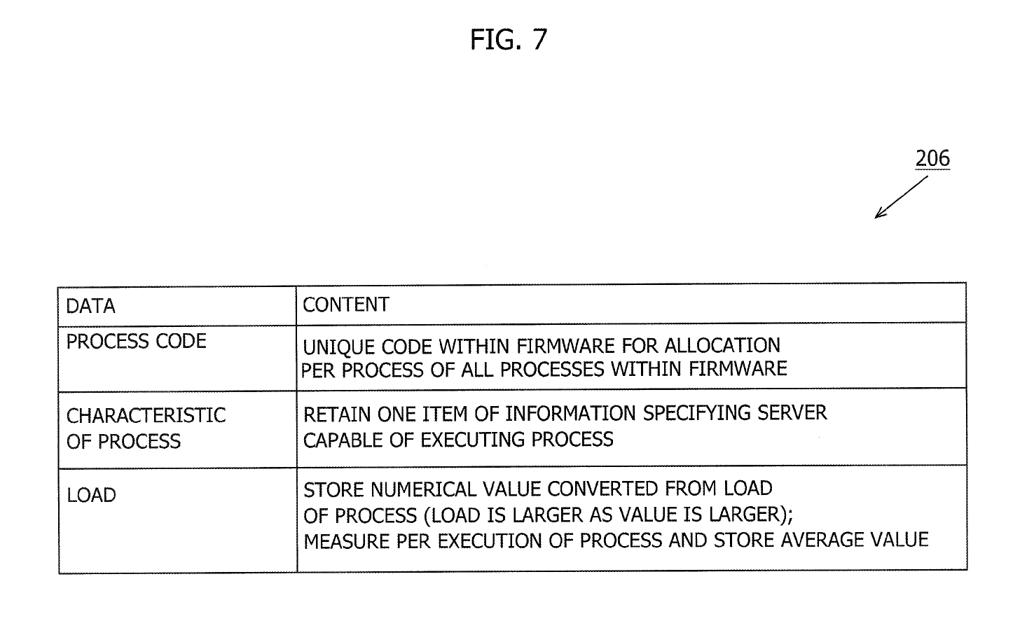

The process information storage unit 206 retains information of respective Processes included by the intra firmware Process 202 on a Process-by-Process basis. The process information storage unit 206 retains the attributes of the firmware 103a capable of executing Process and information indicating a load of the Process by being associated with each other per process. The process status update unit 205 updates the information retained by the process information storage unit 206. When updating the information retained by the process information storage unit 206, the updated information is synchronized with the process information storage units 206 included by the pieces of firmware 103a of other servers 100. FIG. 7 is a diagram illustrating one example of the process information storage unit 206. The information stored in the process information storage unit 206 contains items of information, i.e., a “process code”, a “characteristic of process” and a “load”. The “process code” retains information for identifying each intra firmware Process 202. The information retained in the “process code” is, e.g., a Process name. The “characteristic of process” retains information for specifying the server 100 capable of executing the Process. The “characteristic of process” retains, e.g., one of four types of characteristics of the process, which are described with reference to FIG. 5. The “load” retains a numerical value converted from the load on the Process. The load on the Process is measured each time the Process is executed. The “load” of the process information storage unit 206 retains, e.g., an average value of the measured loads. The process executed by the process information storage unit 206 is one example of a “retaining”.

The server information storage unit 207 retains information of the server 100 included by the information processing system 1 per server 100.

The server information storage unit 207 retains items of information indicating the attributes of the firmware 103a installed in each server 100, the load status of the firmware 103a and the status of the server 100. The firmware 103a of each server 100 retains the server information storage unit 207 of the server 100 installed with the firmware 103a itself, and the server information storage units 207 of other servers 100. In other words, the firmware 103a retains the server information storage units 207 of all the servers 100 included by the information processing system 1. When the information retained in the server information storage unit 207 is updated, the updated information is synchronized with the server information storage units 207 included in the pieces of firmware 103a of other servers 100.

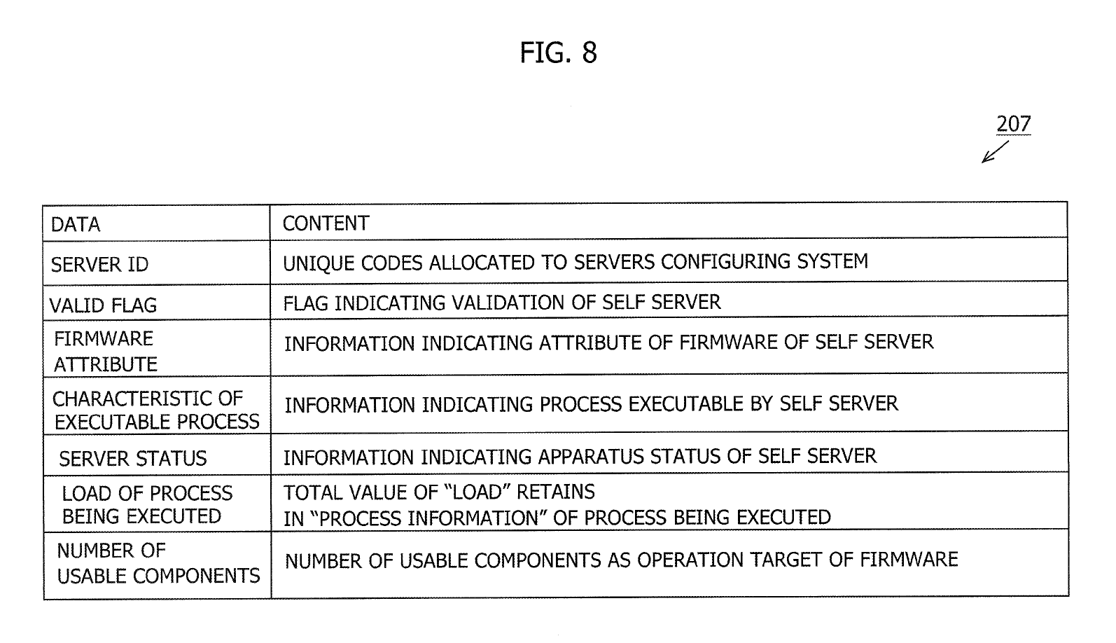

FIG. 8 is a diagram illustrating one example of the server information storage unit 207. The server information storage unit 207 contains respective items of information, i.e., a “server ID”, a “valid flag”, a “firmware attribute”, a “characteristic of executable process”, a “server status”, a “load of process being executed” and a “usable component count”. The “server ID” retains information for uniquely identifying each of the servers 100 included by the information processing system 1. The “server ID” is, e.g., a host name or an Internet Protocol (IP) address. The “valid flag” retains flag information indicating whether the server 100 is valid or not. A “valid” status is a status in which, e.g., the server 100 is connected to the information processing system 1. An “invalid” status is a status in which, e.g., the server 100 is not connected to the information processing system 1. The “valid flag” retains, e.g., “1” when the server 100 is valid and “0” whereas when invalid. A server 100z is not connected to the information processing system 1 as described above. The server 100z is therefore invalid in the information processing system 1. This being the case, “0” is retained in the “valid flag” of the server information storage unit 207 associated with the server 100z. The “firmware attribute” retains an attribute of the firmware 103a installed in the server 100. The “firmware attribute” retains information indicating any one of the Master attribute, the Standby attribute and the Slave attribute as the attribute of the firmware. The “characteristic of executable process” retains a characteristic of the process executable by the firmware 103a installed in the server 100. The “characteristic of executable process” retains information indicating the process executable by the server 100. The “characteristic of executable process” retains, e.g., the characteristic of the process executable by the server 100 in the four types of characteristics of the process, which are described with reference to FIG. 5. The “load of process being executed” retains a value obtained by totaling pieces of information registered in the “load” of the process information storage unit 206 with respect to the intra firmware Process 202 being executed by the firmware 103a.

The “server status” retains information indicating a status of the server 100. The status of the server 100 can be exemplified five statuses 1-5 as follows:
Status 1. A status in an active process from an OFF-state of the non-resident power source to an ON-state of the non-resident power source;
Status 2. A status in the active process from the ON-state of the non-resident power source to the OFF-state of the non-resident power source;
Status 3. A status of turning ON the non-resident power source;
Status 4. A status of turning OFF the non-resident power source; and
Status 5; A status disabled from tuning ON the non-resident power source due to a fault of the component or due to a component being mounted, which is originally inhibited from being mounted.

A throughput of the firmware 103a fluctuates corresponding to the respective statuses 1-5 described above. Such being the case, according to the embodiment, each of the respective statuses 1-5 described above is used as weighting on the “load of process being executed”. In the embodiment, the weighting of the respective statuses is, for example, set to “1.5” in the case of the status 1, “1.25” in the case of the status 2, “1.0” in the case of the status 3, “0.5” in the case of the status 4, and “0.25” in the case of the status 5. For example, when the server 100 is in the status 1, a product of a value of the “load of process being executed” and the weight “1.5” of the status 1 is computed, and the computed value can be set as a load of the firmware 103a. The weight indicated by the “server status” is one example of a “status value determined per operation status”.

The “usable component count” retains a number of hardware resources set as control targets of the firmware 103a in the hardware resources instanced by the CPU 101 mounted in the server 100. The control target components (resources) connote, e.g., the hardware resources with no fault being caused in the hardware resources mounted in the server 100.

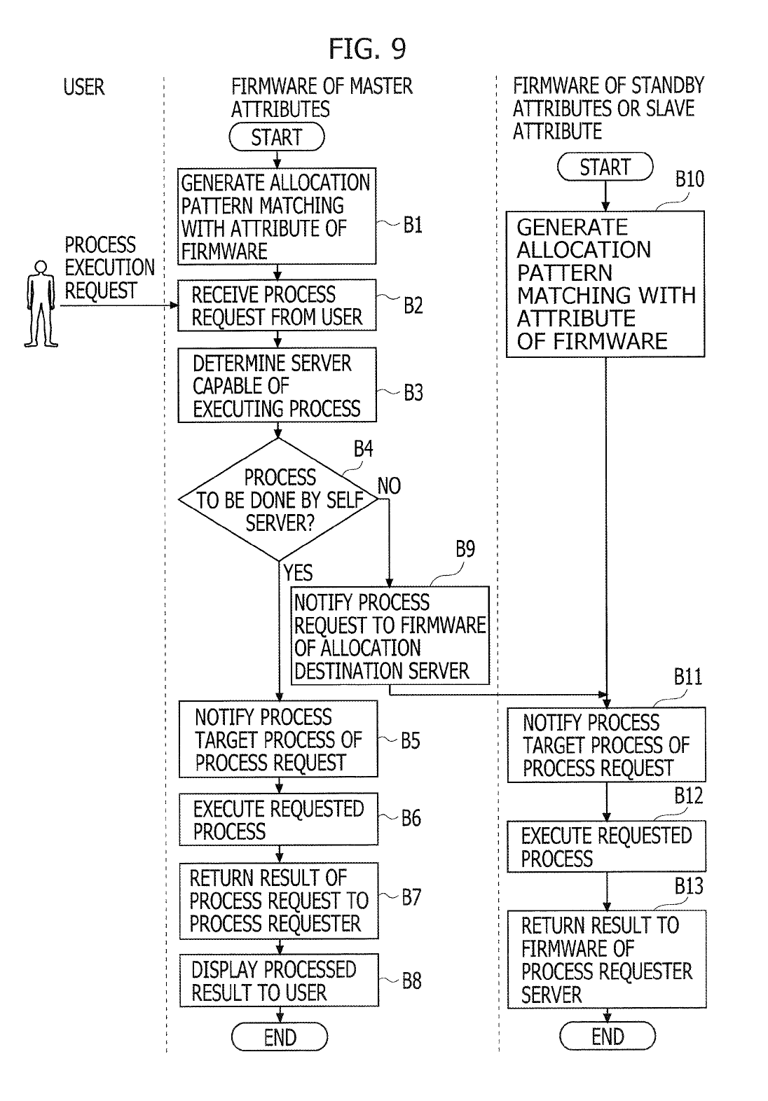

FIG. 9 is a flowchart illustrating one example of a processing flow when accepting the process request from the user. One example of the processing flow when accepting the process request from the user will hereinafter be described with reference to FIG. 9.

Processes from B1 through B9 are processes to be executed by the firmware 103a having the Master attributes. In B1, it is determined how the processes are allocated corresponding to the attributes of the firmware 103a. The determined information is retained in the “characteristic of executable process” of the server information storage unit 207. The process in B1 is a process to be executed after determining the attributes with respect to the firmware 103a of each server 100.

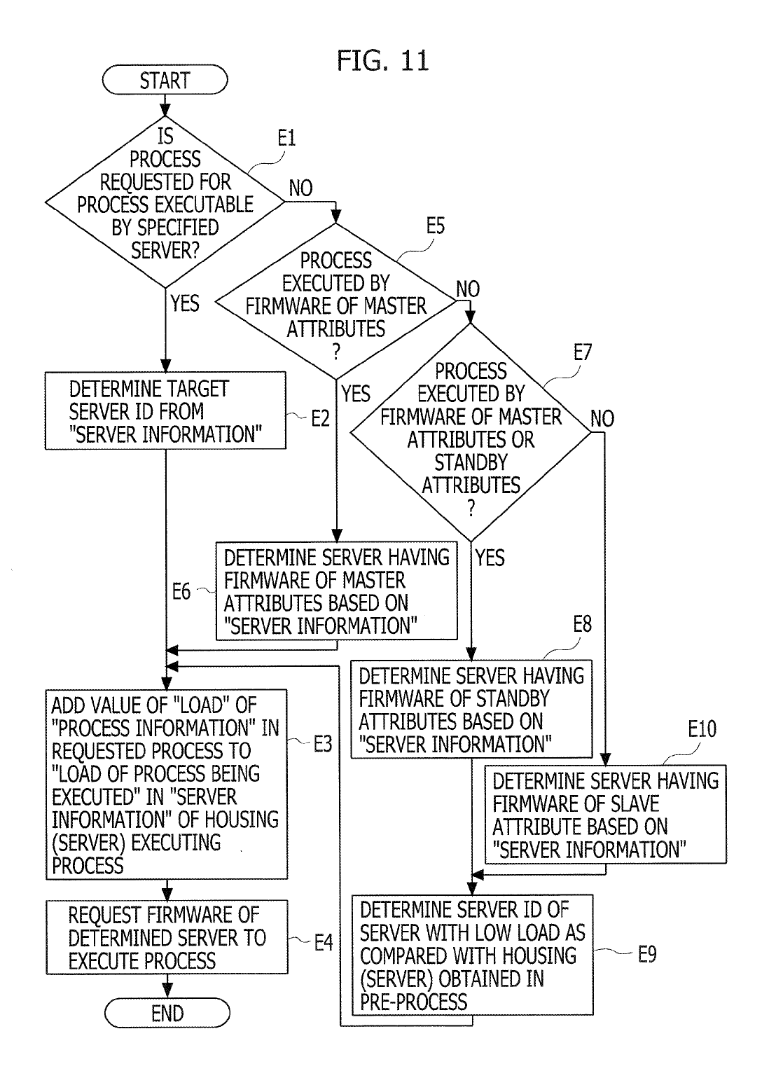

In B2, the user I/F 201 receives a request for executing the process from the user. The process execution request is made by, e.g., inputting a command to the user I/F 201. The inputted command specifies an execution target Process in the intra firmware Process 202. In B3, the inter server process request determination unit 204 determines the server 100 that is made to execute the process with the execution request being accepted in B2. An in-depth description of the process in B3 will be made later on with reference to FIG. 11. As a result of the process in B3, when the requested process is a process to be executed by the self server (YES in B4), the processing advances to B5. Whereas when the requested process is not the process to be executed by the self server (NO in B4), the processing diverts to B9.

In B5, the request manager 203 requests the Process specified in B2 to execute the process. In B6, the Process requested to execute the process in B5 executes the requested process. In B7, the Process finishing the process in B6 notifies the request manager 203 of a processed result. In B8, the user I/F 201 outputs the processed result, notified to the request manager 203, to the output unit 306. In B9, the request manager 203 requests the firmware 103a of the server 100 determined in B3 to execute the process.

The processes in B10-B13 are processes to be executed by the firmware 103a having the Standby attributes or the firmware 103a having the Slave attribute. The processes in B10-B12 are the same as B1, B5 and B6 except a point that a process execution entity is the firmware 103a having the Standby attributes or the firmware 103a having the Slave attribute. The repetitive explanations of these processes are therefore omitted. In B13, the Process finishing the process in B12 notifies the processed result to the request manager 203 of the firmware 103a containing the self Process. The request manager 203 notified of the processed result notifies the processed result to the request manager 203 of the firmware 103a having the Master attributes.

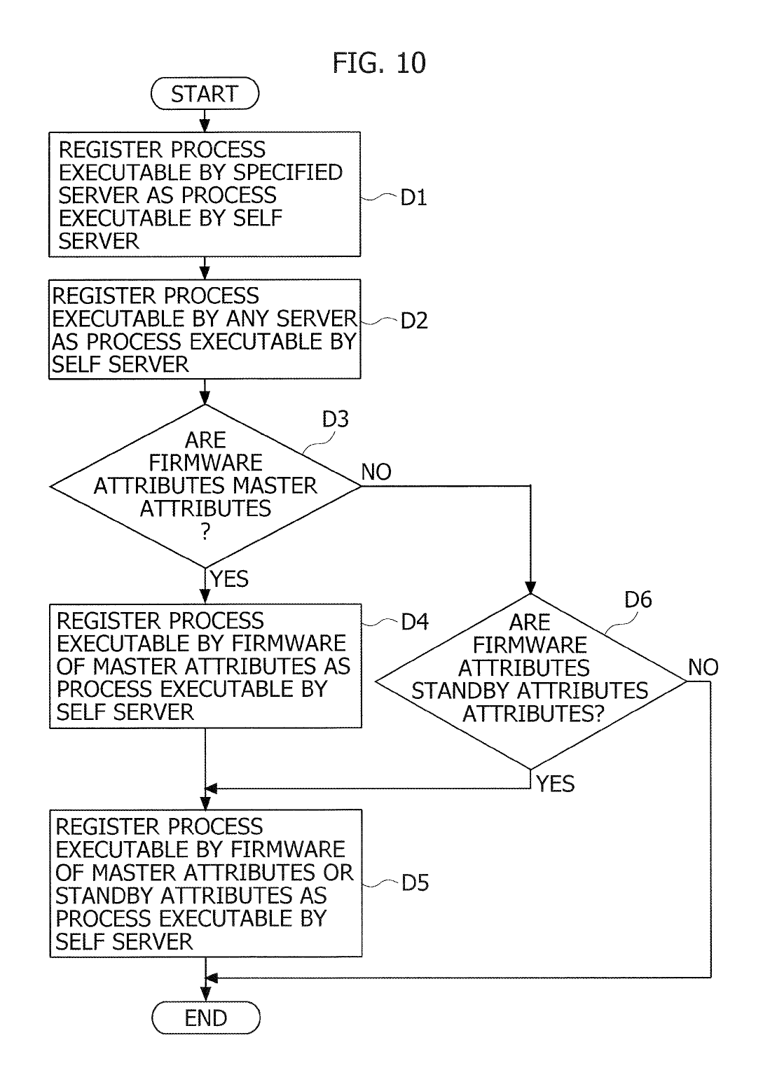

FIG. 10 is a flowchart illustrating one example of an allocation pattern generation process corresponding to the attributes of the firmware 103a. FIG. 10 is one example of the flowchart used for making an in-depth description of the processes in B1 and B10 in FIG. 9. The allocation pattern generation process illustrated in FIG. 10 is executed by the firmware 103a of each of the servers 100. One example of the allocation pattern generation process corresponding to the attributes of the firmware 103a will hereinafter be described with reference to FIG. 10.

In D1, the process status update unit 205 registers a “process executable by specified server” in the “characteristic of executable process” of the server information storage unit 207. In D2, the process status update unit 205 registers a “process executable by any server” in the “characteristic of executable process” of the server information storage unit 207.

When the attributes of the firmware 103a are the Master attributes (YES in D3), the processing advances to D4. Whereas when the attributes of the firmware 103a are not the Master attributes (NO in D3), the processing diverts to D6.

In D4, a “process executable by firmware having Master attributes” is registered in the “characteristic of executable process” of the server information storage unit 207. In D5, a “process executable by firmware having Master attributes and Standby attributes” is registered in the “characteristic of executable process” of the server information storage unit 207.

In D6, when the attributes of the firmware 103a are the Standby attributes (YES in D6), the processing advances to D5. Whereas when the attributes of the firmware 103a are not the Standby attributes (NO in D6), the processing is finished.

FIG. 11 is a flowchart illustrating one example of allocating the process of receiving the execution request to each firmware 103a. The process in FIG. 11 is one example of the flowchart used for making an in-depth description of the processes B2-B5 and B9 in FIG. 9. The process in FIG. 11 is executed on the service processor 103 accepting the process request. One example of allocating the process of receiving the execution request to each firmware 103a will hereinafter be described with reference to FIG. 11.

In E1, the inter server process request determination unit 204 determines whether the Process specified in B2 of FIG. 9 is a Process executable by the specified server 100 by referring to the “characteristic of process” of the process information storage unit 206. When the requested Process is the Process executable by the specified server (YES in E1), the processing advances to E2. Whereas when the requested Process is not the Process executable by the specified server (NO in E1), the processing diverts to E5.

In E2, the inter server process request determination unit 204 acquires a server ID from the server information storage unit 207 associated with the self server by the server ID. In E3, the inter server process request determination unit 204 refers to the “load” of the process information storage unit 206, which is associated with the Process specified in B2 of FIG. 9, thereby acquiring a value indicating the load of the process concerned. The inter server process request determination unit 204 adds the acquired value indicating the load of the process to the “load of process being executed” of the server information storage unit 207 associated by the server ID acquired in the process of E2. In E4, the firmware 103a of the server 100 determined as a requestee of the process is requested to execute the Process.

In E5, the inter server process request determination unit 204 determines whether the Process specified in B2 of FIG. 9 is a Process to be executed by the firmware 103a having the Master attributes. For making the determination in E5, the inter server process request determination unit 204 refers to the “characteristic of process” of the process information storage unit 206, which is associated with the Process specified in B2 of FIG. 9. When information indicating the Process to be executed by the firmware 103a having the Master attributes is registered in the “characteristic of process”, the inter server process request determination unit 204 determines that the requested Process is the Process to be executed by the firmware 103a having the Master attributes. When the requested Process is the Process to be executed by the firmware 103a having the Master attributes (YES in E5), the processing advances to E6. Whereas when the requested Process is not the Process to be executed by the firmware 103a having the Master attributes (NO in E5), the processing diverts to E7.

In E6, the inter server process request determination unit 204 specifies the server information storage unit 207 in which the information registered in the “firmware attribute” of the server information storage unit 207 indicates the firmware 103a having the Master attributes. The inter server process request determination unit 204 acquires the server ID registered in the “server ID” of the thus-specified server information storage unit 207.

In E7, the inter server process request determination unit 204 determines whether the requested Process is a Process to be executed by the firmware 103a having the Master attributes or the Standby attributes by referring to the “characteristic of process” of the process information storage unit 206, which is associated with the Process specified in B2 of FIG. 9. When the requested Process is the Process to be executed by the firmware 103a having the Master attributes or the Standby attributes (YES in E7), the processing advances to E8. Whereas when the requested Process is not the Process to be executed by the firmware 103a having the Master attributes or the Standby attributes (NO in E7), the processing diverts to E10.

In E8, the inter server process request determination unit 204 selects the server information storage units 207 in which information registered in the “firmware attribute” specifies the firmware 103a having the Standby attributes by referring to the “firmware attribute” of each server information storage unit 207. The inter server process request determination unit 204 specifies the server information storage unit 207 with the “valid flag” being valid from within the selected server information storage units 207. The inter server process request determination unit 204 acquires the server ID registered in the “server ID” of the specified server information storage unit 207. The inter server process request determination unit 204 may acquire a plurality of server IDs when the plurality of relevant server IDs exists.

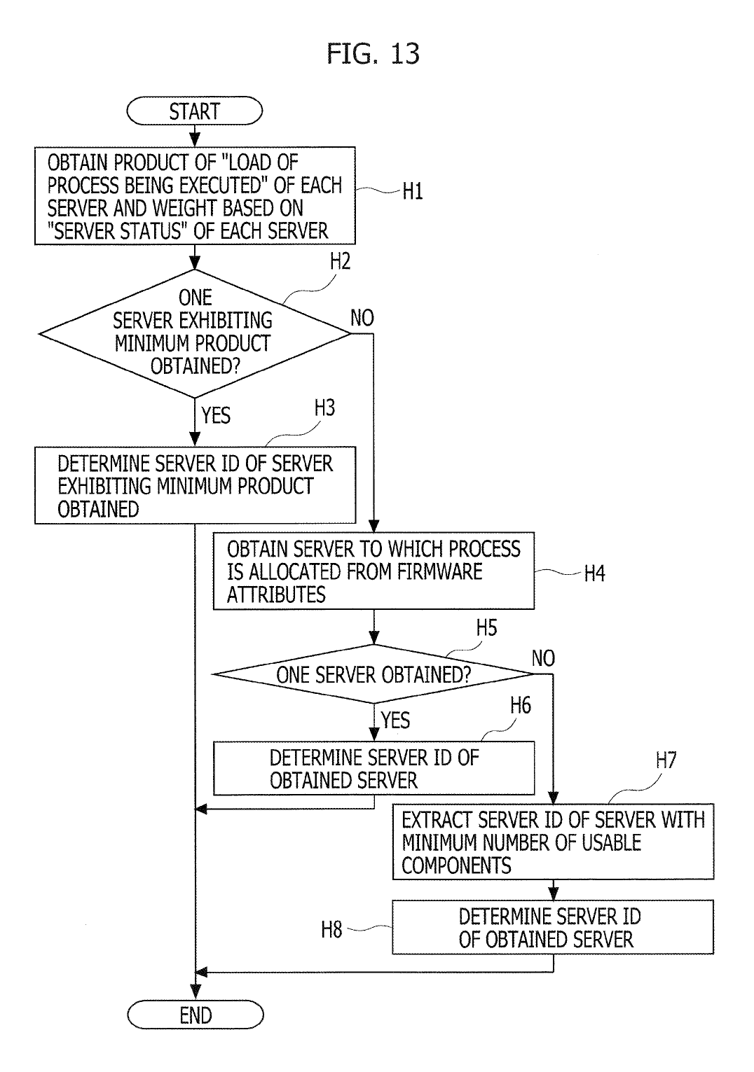

In E9, the inter server process request determination unit 204 determines the server 100 exhibiting a low load in the servers 100 specified by the server IDs determined in E8 or E10. The inter server process request determination unit 204 selects the server information storage unit 207 exhibiting the lowest value of the “load of process being executed” of the server information storage unit 207 specified by the determined server ID. The inter server process request determination unit 204 acquires the server ID registered in the “server ID” of the selected server information storage unit 207. The inter server process request determination unit 204 determines the acquired server ID as the server ID of the server 100 with the low load. Details of the process in E9 will be described with reference to FIG. 13. The processes in S9 and E4 are one example of a process of “selecting a control unit exhibiting a low processing load as compared with processing loads of the selected control units when a plurality of selected control units exists”.

In E10, the inter server process request determination unit 204 selects the server information storage units 207 in which information registered in the “firmware attribute” indicates the firmware 103a having the Slave attribute by referring to the “firmware attribute” of each server information storage unit 207. The inter server process request determination unit 204 specifies the server information storage unit 207 with the “valid flag” being valid from within the selected server information storage units 207. The inter server process request determination unit 204 acquires the server ID registered in the “server ID” of the specified server information storage unit 207. The inter server process request determination unit 204 acquires a plurality of server IDs when the plurality of relevant server IDs exists.

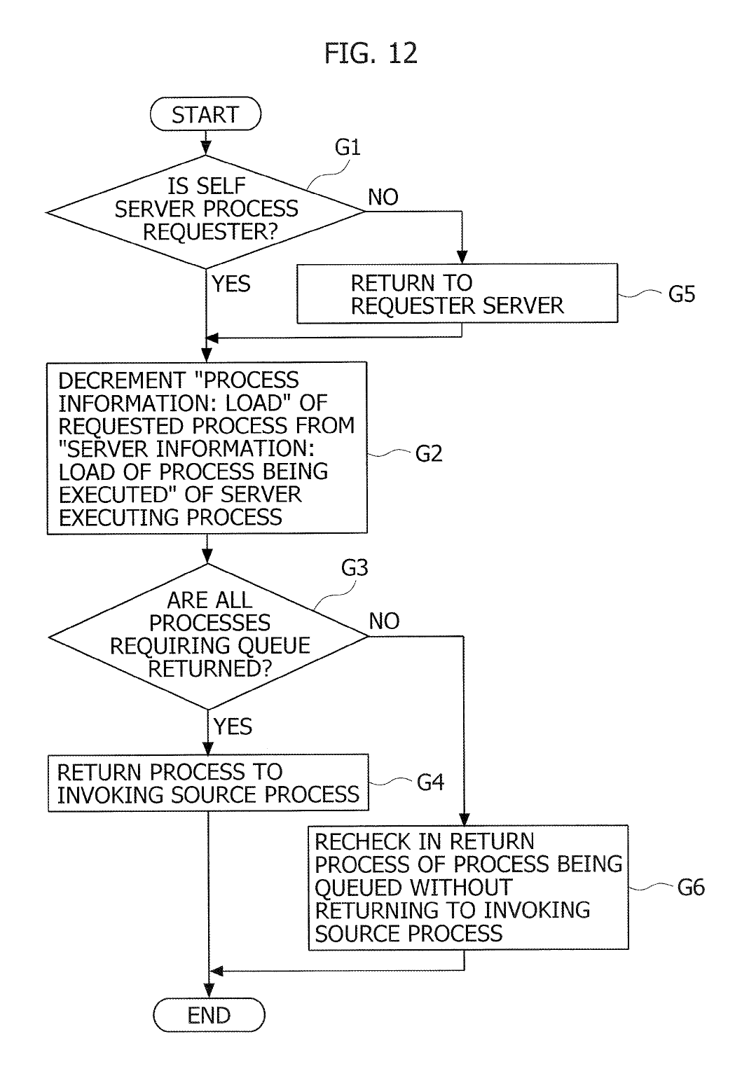

FIG. 12 is a flowchart illustrating one example of a process of returning to an invoking source upon completing the requested Process. The process in FIG. 12 is one example of the flowchart used for making an in-depth description of the processes in B7 and B13 of FIG. 9. One example of the process of returning to the invoking source upon completing the requested Process will hereinafter be described with reference to FIG. 12.

In G1, a subsequent process is diverted by a requester of the Process. When the requester of the Process is the self server (YES in G1), the processing advances to G2. Whereas when the requester of the Process is not the self server (NO in G1), the processing diverts to G5. In G2, the process status update unit 205 receives notification indicating an end of the requested Process from the request manager 203. The process status update unit 205 acquires a value indicating the “load” of the finished Process from the “load” of the process information storage unit 206, which is associated with the Process with the process being finished. The process status update unit 205 decrements the value indicating the “load” of the finished Process from the“load of process being executed” of the server information storage unit 207, which is associated with the self server.

In G3, when there exist other Processes synchronizing with the finished Process, it is determined whether other Processes are completed. When other Processes are completed (YES in G3), the processing advances to G4. Whereas when other Processes are not completed (NO in G3), the processing diverts to G6.

In G4, the Process completing the process notifies the invoking source Process that the process is completed. The Process completing the process, when the invoking source Process is, e.g., the request manager 203, notifies the request manager 203 that the process is completed. The Process completing the process, when there exist other Processes taking the synchronization, notifies other Processes that the process is completed.

In G5, the Process completing the process notifies the request manager 203 of the invoking source server 100 that the process is completed. In G6, other Processes taking the synchronization are not completed. Hence, the Process does not report the completion of the process to the invoking source Process, but finishes processing.

FIG. 13 is a flowchart illustrating one example of a process of selecting the server 100 exhibiting the low load. The process in FIG. 13 is one example of the flowchart used for making an in-depth description of the process in E9 of FIG. 11. One example of the process of selecting the server 100 exhibiting the low load will hereinafter be described with reference to FIG. 13.

In H1, the inter server process request determination unit 204 computes a product of the “load of process being executed” of the server information storage unit 207 and the weight of the server status that is given in the “server status” with respect to each of the servers 100 included in the information processing system 1. In H2, the inter server process request determination unit 204 determines whether the number of servers 100, in which the product computed in H1 takes a minimum value, is “1” or not. When the number of servers 100, in which the product computed in H1 takes the minimum value, is “1” (YES in H2), the processing advances to H3. Whereas when the number of servers 100, in which the product computed in H1 takes the minimum value, is not “1” (NO in H2), the processing diverts to H4.

In H3, the inter server process request determination unit 204 acquires, from the server information storage unit 207, the server ID of the server 100 having the minimum value of the product computed in H1. The processes in H3 and E4 of FIG. 11 are one example of a process of “computing a second processing load by weighting based on a status value (207: “server status”) determined per operation status of the information processing apparatus with respect to the processing load, and selecting the control unit with the second processing load being low“.

In H4, the inter server process request determination unit 204 selects the server 100 that executes the Process according to a priority level set per attribute of the firmware 103a from within the plurality of servers 100 each taking the minimum value of the product computed in H1. In H4, the priority level per attribute of the firmware 103a is a sequence of, e.g., the Slave attribute, the Standby attribute and the Master attribute. Herein, one example of the process in H4 will be described. For example, it is assumed that the servers 100, in which the product computed in H1 takes the minimum value, are the server 100b and the server 100d. In the case of this example, the server 100b includes the firmware 103a having the Standby attributes, and the server 100d includes the firmware 103a having the Slave attribute. Therefore, in the case of this example, the server 100d including the firmware 103a having the Slave attribute is selected.

In H5, the inter server process request determination unit 204 determines whether the number of the servers 100 selected in H4 is “1” or not. When the number of the selected servers 100 is “1” (YES in H5), the processing advances to H6. Whereas when the number of the selected servers 100 is not “1” (NO in H5), the processing diverts to H7.

In H6, the inter server process request determination unit 204 acquires the server ID of the server 100 selected in H4 from the server information storage unit 207. In H7, the inter server process request determination unit 204 selects the server 100 exhibiting a minimum “usable component count” from within the servers 100 selected in H4 by referring to the server information storage unit 207. In H8, the inter server process request determination unit 204 acquires the server ID of the server 100 selected in H7 from the server information storage unit 207. Note that it may be sufficient that the inter server process request determination unit 204, when there exists the plurality of servers 100 selected in H7, selects the server ID of an arbitrary server 100 in the servers 100 selected in H7 from the server information storage unit 207. The processes in H7 and E4 of FIG. 11 are one example of a process of “selecting the control unit equipped in an information processing apparatus exhibiting a small number of hardware resources mounted in the information processing apparatus”.

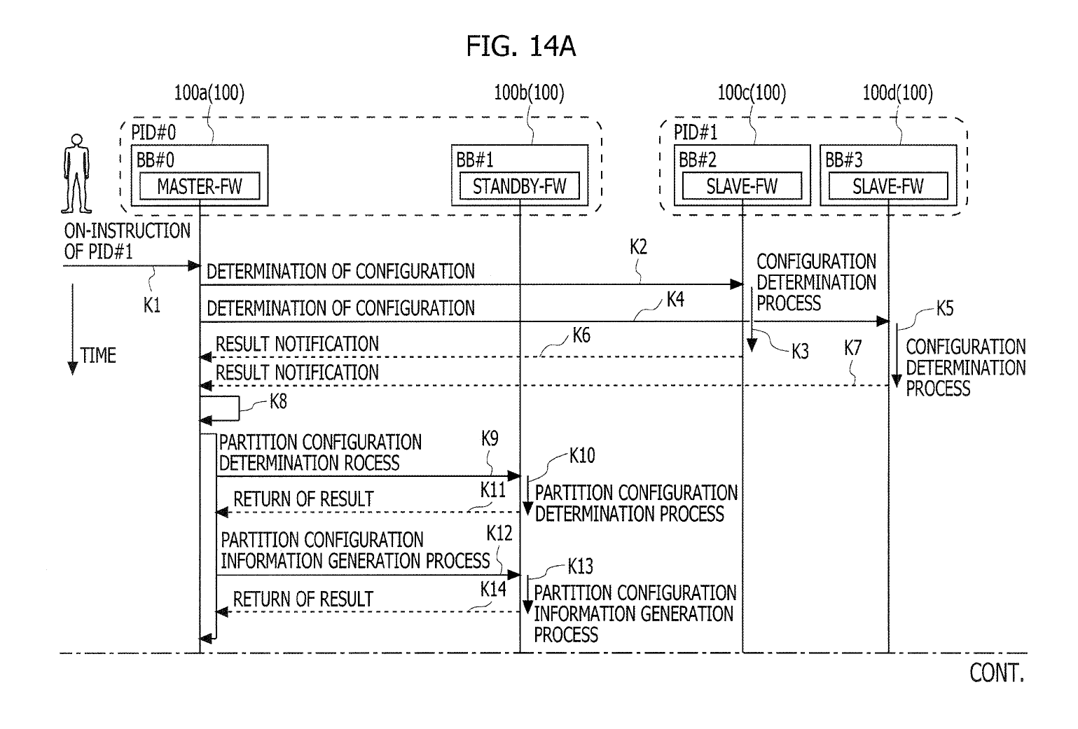

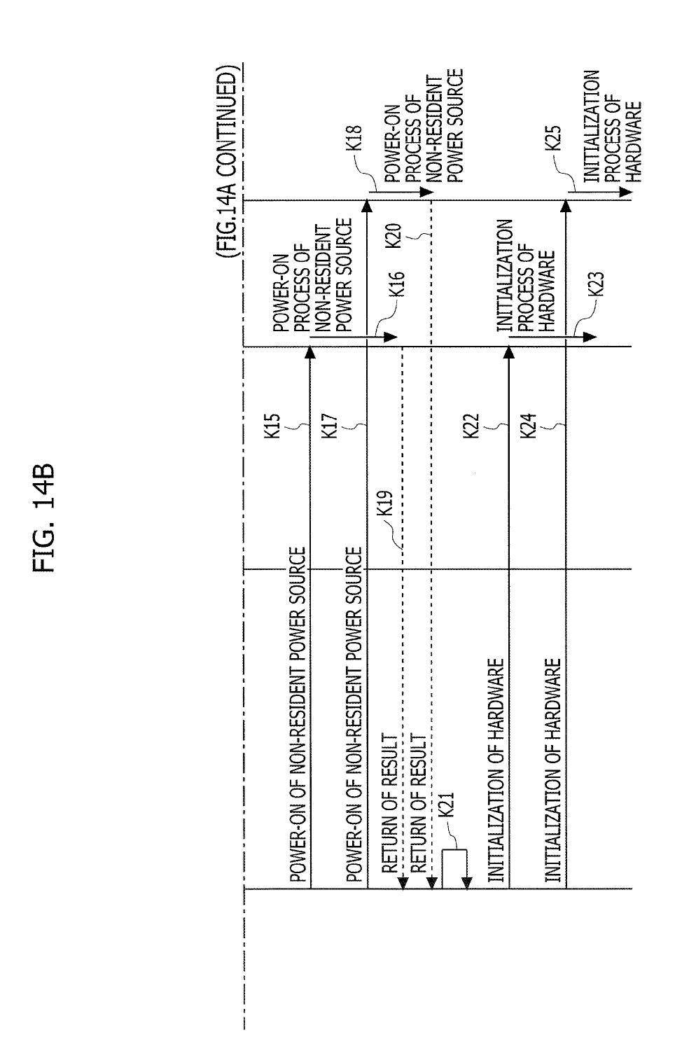

Based on the description made so far, a partition power-ON process in the information processing system 1 according to the embodiment will be described. FIGS. 14A and 14B are diagrams illustrating one example of the partition power-ON process in the information processing system 1 according to the embodiment. In FIGS. 14 A and 14B, a partition PID#0 is created by the server 100a and the server 100b. A partition PID#1 is created by the server 100c and the server 100d. The Master attributes are set in the firmware 103a of the server 100a. The Standby attributes are set in the firmware 103a of the server 100b. The Slave attribute is set in the pieces of firmware 103a of the servers 100c and 100d. In FIGS. 14 A and 14B, a power source of the partition PID#1 is turned ON in response to a request given from the user. Herein, in respective processes illustrated in FIGS. 14 A and 14B, processes in K10 and K13 are to be processes executable by any of the firmware 103a having the Master attributes and the firmware 103a having the Standby attributes. One example of the partition power-ON process in the information processing system 1 according to the embodiment will hereinafter be described with reference to FIGS. 14 A and 14B.

In K1, the service processor 103 of the server 100a including the firmware 103a having the Master attributes accepts a command for turning ON the power source of the partition PID#1 from the user via the user I/F 201. In K2, the firmware 103a of the server 100a makes a request for a configuration determination process of the server 100c contained in the partition PID#1. The configuration determination process is a process of determining whether a variety of hardware components mounted in, e.g., the server 100c normally operate. The server 100 becoming a requestee of the configuration determination process is selected according to the processes illustrated in FIG. 11. It is herein assumed that the server 100c is selected as the server to execute the configuration determination process of the server 100c. Then, the firmware 103a of the server 100a requests the server 100c for the configuration determination process.

In K3, the firmware 103a of the server 100c receives the request from the server 100a. The firmware 103a receiving the request executes the configuration determination process. In K6, the firmware 103a executing the configuration determination process determines a recipient server of processed result notification, which is determined in accordance with the processes illustrated in FIG. 12. Herein, the server 100a is determined as the recipient server of the processed result notification. The firmware 103a of the server 100c notifies the server 100a of a result of the configuration determination. The firmware 103a of the server 100a shares the received result with the firmware 103a of the server 100b in which to set the Standby attributes. There is no limit to a method of sharing the received result between the firmware 103a of the server 100a and the firmware 103a of the server 100b. The firmware 103a of the server 100a may also transmit the received result to the firmware 103a of the server 100b via the network N1. The firmware 103a of the server 100a may also store the received result in a storage device shared between, e.g., the service processor 103 of the server 100a and the service processor 103 of the server 100b. Processes in K4, K5 and K7 are the same as the processes in K2, K3 and K6. Hence, the repetitive explanations thereof are omitted. In K8, the firmware 103a of the server 100a stands by till the results of the configuration determination processes are all given from the server 100c and the server 100d.

The processes executed in K10 and K13 are, as stated above, processes executable by any of the firmware 103a having the Master attributes and the firmware 103a having the Standby attributes. This being the case, the firmware 103a of the server 100a determines a process requestee according to the processes illustrated in FIG. 11. Herein, the firmware 103a of the server 100b is to be determined as the process requestee. The firmware 103a of the server 100a requests the firmware 103a of the server 100b to execute the process. In K10, the firmware 103a, requested to execute the process, of the server 100b executes a partition configuration determination process of the server 100c. The partition configuration determination process is a process of determining whether the server 100 can assemble the partition PID#1. In K11, the firmware 103a of the server 100b determines the processed result notification recipient in accordance with the processes illustrated in FIG. 12. Herein, the firmware 103a of the server 100 as the process requester is notified of the processed result. The request manager 203 of the server 100b notifies a result of the partition configuration determination process in K10 to the firmware 103a of the server 100a. In K12, the firmware 103a of the server 100b determines the process requestee according to the processes illustrated in FIG. 11. Herein also, it is assumed that the firmware 103a of the server 100b is determined as the process requestee. In K13, the firmware 103a, requested to execute the process, of the server 100b executes the partition configuration determination process from statuses of the components configuring the partition on the basis of the result of the process in K10. In K14, the firmware 103a of the server 100b determines the processed result notification recipient in accordance with the processes depicted in FIG. 12. Herein, the firmware 103a of the server 100 as the process requester is notified of the processed result.

In K15, the firmware 103a of the server 100a requests the server 100b to turn ON the non-resident power source. In K16, the firmware 103a of the server 100b turns ON the non-resident power source of the server 100b. Processes in K17 and K18 are the same as the processes in K15 and K16. Hence, the repetitive explanations thereof are omitted. In K19, the firmware 103a of the server 100c determines the processed result notification recipient according to the processes illustrated in FIG. 12. Herein, the firmware 103a of the server 100c notifies the processed result to the firmware 103a of the server 100a as the process requester. A process in K20 is the same as the process in K19. Accordingly, the repetitive explanation thereof is omitted. In K21, the firmware 103a of the server 100a stands by till the power-ON of the non-resident power sources of the server 100c and the server 100d is completed.

In K22, the firmware 103a of the server 100a requests the server 100c to initialize the hardware. The hardware initialization includes a process of initializing, e.g., a device driver of the hardware. In K23, the firmware 103a of the server 100c executes initializing the hardware. Processes in K24 and K25 are the same as the processes in K22 and K23, and hence the repetitive explanations thereof are omitted.

### Comparative Example

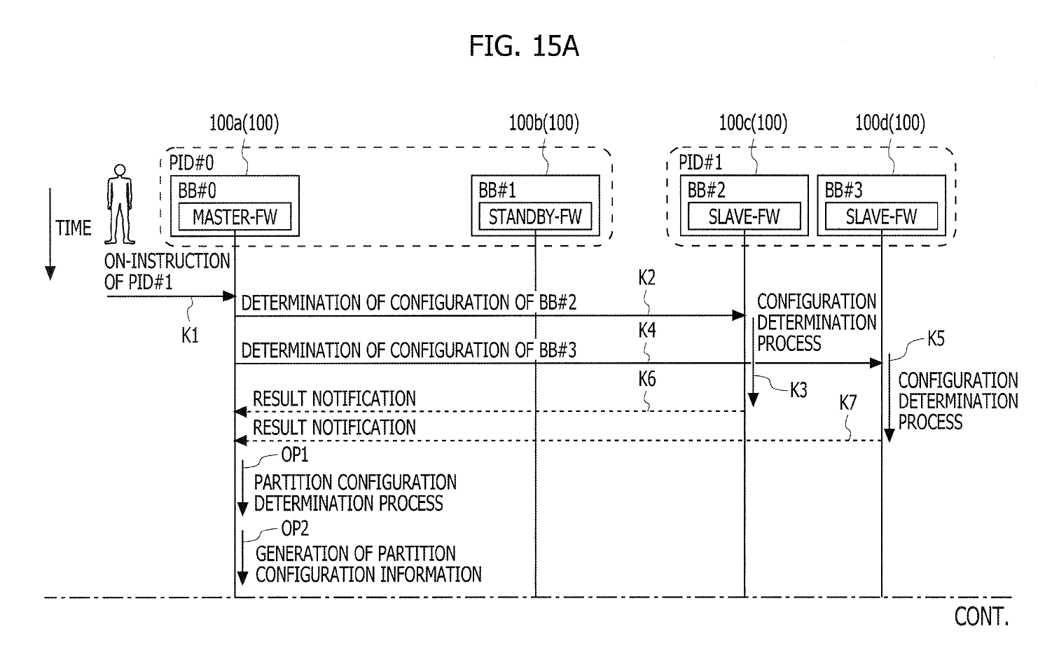

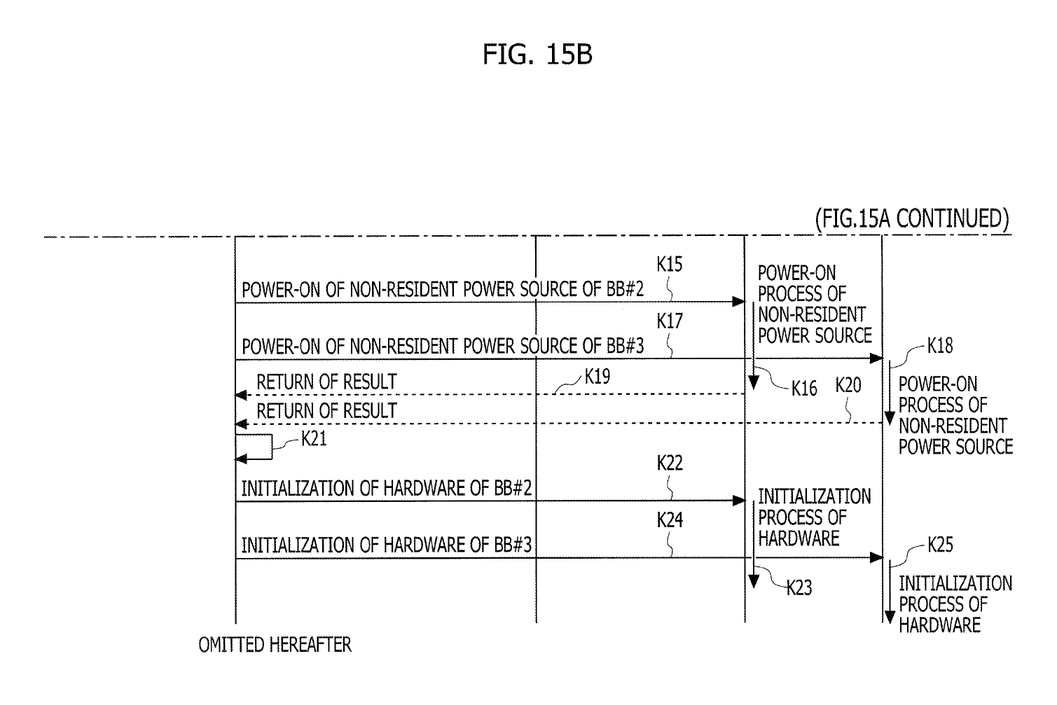

Herein, a comparative example for a comparison with the embodiment will be described. FIGS. 15A-15B are diagrams illustrating one example of a processing flow of turning ON the power source of the partition in an information processing system according to the comparative example. The information processing system according to the comparative example is substantially the same as in the embodiment except a point of its being disabled from allocating the requested process to other pieces of firmware 103a. In other words, in the information processing system according to the comparative example, the firmware 103a accepting the request executes the requested process. The same processes as those in FIGS. 14A and 14B are marked with the same numerals and symbols, and the repetitive explanations thereof are omitted. The comparative example will hereinafter be described with reference to FIGS. 15A and 15B.

In OP1, the firmware 103a of the server 100a executes the partition configuration determination process of the server 100c. In OP2, the firmware 103a of the server 100a generates partition configuration information of the server 100d.

The partition PID#1 is started up by the processes in FIGS. 15A and 15B as described above. The respective processes in FIGS. 15A and 15B are executed based on an instruction given from the firmware 103a having the Master attributes. Herein, the firmware 103a having the Master attributes and the firmware 103a having the Standby attributes are accessible to the same information. Therefore, e.g., the processes in OP1 and OP2 of FIG. 15 are executable by the firmware 103a having any of the Master attributes and the Standby attributes. The information processing system according to the comparative example does not, however, include a mechanism for allocating the process accepted from the user to other pieces of firmware 103a. Consequently, in the information processing system according to the comparative example, the firmware 103a having the Master attributes, which accepts the request from the user, executes both of OP8 and OP9. Hence, in the information processing system according to the comparative example, the processing load is easy to concentrate on the firmware 103a having the Master attributes.

By contrast, in the embodiment, as illustrated in K9-K14 of FIGS. 14A and 14B, the processes executable by the firmware other than the firmware 103a having the Master attributes are shared with the firmware 103a having other attributes. Therefore, the information processing system 1 according to the embodiment enables a reduction of the processing load on the firmware 103a having the Master attributes as compared with the information processing system according to the comparative example, in which firmware 103a having the Master attributes executes all the processes.

<Effect of Embodiment>

In the embodiment, the allocation destination of the requested Process is determined based on the “characteristic of process” in the process information storage unit 206 provided per Process requested to execute the process and the attributes of the firmware 103a. Hence, according to the embodiment, a processing bias to the specified firmware 103a is restrained as compared with such a case that the firmware 103a accepting the process request executes all the requested processes.

In the embodiment, when there exists the plurality of firmware 103a capable of executing the requested processes, the requested processes are allocated to the pieces of firmware 103a exhibiting the low processing load. The embodiment therefore enables the processing load on the firmware 103a to be distributed.

In the embodiment, the server 100, to which the requested process is allocated, is selected after weighting based on the “server status” in the server information storage unit 207 with respect to the processing load on the firmware 103a. Consequently, according to the embodiment, the proper firmware 103a can be requested to execute the process corresponding to the server status of the server 100 and the processing load on the firmware 103a.

Selected in the embodiment is the firmware 103a requested to execute the processes, corresponding to the number of hardware resources controlled by the firmware 103a. It is considered that the processing load on the firmware 103a is easy to become higher with the larger number of hardware resources controlled by the firmware 103a. According to the embodiment, it is therefore feasible to select the firmware 103a being hard to get higher in processing load by selecting the firmware 103a requested to execute the process corresponding to the number of hardware resources controlled by the firmware 103a.

<Modification of Embodiment>

The information processing system 1 according to the embodiment can include the five servers 100 at the maximum. There is, however, no limit to the number of the servers 100 included by the information processing system 1. The information processing system 1 can include an arbitrary number of servers 100.

The embodiment has described the method of restraining the processing bias to the specified firmware 103a in a way that takes, for one example, the information processing system 1 configured to create the partition by combining one or the plurality of servers 100. The system, to which the method of restraining the processing bias to the specified firmware 103a can be applied, has been described in the embodiment but is not limited to the information processing system 1 configured to create the partition. It may be sufficient that the information processing system described in the embodiment, to which the method of restraining the processing bias to the specified firmware 103a can be applied, is the information processing system configured to connect the plurality of servers each including the firmware receiving the setting of the attributes corresponding to the contents of the processes.

The embodiment and the modified examples, which are disclosed so far, can be combined respectively.

The present information processing system is capable of restraining the bias of the processing load to the specified control unit.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a plurality of information processing apparatuses configured to be connected in a communicable manner,
each of the information processing apparatuses including a control unit, the control unit being set attributes corresponding to executable processes, the control unit including:
a memory; and
a processor coupled to the memory and the processor conrigured to perform:
retaining an associative relation between processes executed by any of the controling and the attributes enabling execution of the processes;
accepting a process execution request;
selecting the control unit to execute the process with the execution request being accepted in accordance with the associative relation; and
requesting the selected control unit to execute the requested process.

2. The information processing system according to claim 1, wherein the selecting further includes, when a plurality of selected control units exists, a process of selecting the control unit exhibiting a low processing load as compared with the processing loads of the selected control units.

3. The information processing system according to claim 2, wherein the selecting further includes a process of computing a second processing load by weighting based on a status value determined per operation status of the information processing apparatus with respect to the processing load, and selecting the control unit exhibiting a low second processing load.

4. The information processing system according to claim 1, wherein the selecting further includes a process of selecting the control unit equipped in the information processing apparatus exhibiting a small number of hardware resources mounted in the information processing apparatus.
